(19) United States
(12) Patent Application Publication
(10) Pub. No.: US 2019/0071007 A1
(43) Pub. Date: Mar. 7, 2019

(54) SWEEP LIGHT POINTER

(71) Applicant: VISTEON GLOBAL TECHNOLOGIES, INC., Van Buren Township, MI (US)

(72) Inventors: Fabrice Razafindrabeza, Flins sur Seine (FR); Yahia Hammiche, Argenteuil (FR); Jean Luc Croy, Cergy Pontoise Cedex (FR); Georges Prigent, Cergy Pontoise Cedex (FR)

(21) Appl. No.: 15/696,971

(22) Filed: Sep. 6, 2017

(51) Int. Cl. B60Q 3/14; F21V 3/02; F21V 7/22; H05B 37/02; G01D 7/00; G01D 13/22; B60K 35/00; B60K 37/02

(52) U.S. Cl. CPC B60Q 3/14; F21V 3/02; F21V 7/22; H05B 37/029; F21Y 2115/10; G01D 13/22; B60K 35/00; B60K 37/02; G01D 7/00

(57) ABSTRACT

An instrument cluster for a vehicle includes a gauge having a face plate, a pointer rotatably coupled to the face plate, and a gauge indicator on the face plate. The pointer includes an arm with a bottom plate and a top plate on opposed sides of the arm, a reflector coupled to the bottom plate, and a light source coupled to the bottom plate. The light source is positioned to emit a light along the arm and the reflector is positioned to reflect the light through the top plate.

### BACKGROUND

A vehicle typically includes an instrument cluster located within a field of view of an occupant. The instrument cluster is a set of instrumentation with gauges that display information to the occupant. The gauges may be digital gauges or analog gauges. The digital gauges use a digital readout to inform the occupant of performance stats in a vehicle. The analog gauges, on the other hand, are mechanical products that display a reading via a pointer attached to a face plate and rotated to point to information of a gauge indicator. Pointers in the instrument cluster are mainly built with a couple of plastic parts. Typically, a separated backlight source on a hardware PCB board provides light that enters at the base of the pointer's cylinder axis (the pointer's shaft) or below the pointer's cap area. The conventional manner for performing this implementation is to provide light via a PCB and reflect said light through a reflector dish in the cap. The light is guided and then reoriented along the pointer tip. In this arrangement, the pointer is lighted almost uniformly. Such pointers are unable to offer light animation, such as providing high light or a sweeping light that goes from one extremity to the other extremity of the pointer or pointing differently at information.

### SUMMARY

This section provides a general summary of the present disclosure and is not a comprehensive disclosure of its full scope or all of its features, aspects, and objectives.

Disclosed herein are implementations of an instrument cluster for a vehicle that includes a gauge having a face plate, a pointer rotatably coupled to the face plate, and a gauge indicator on the face plate. The pointer includes an arm with a bottom plate and a top plate on opposed sides of the arm, a reflector coupled to the bottom plate, and a light source coupled to the bottom plate. The light source is positioned to emit a light along the arm and the reflector is positioned to reflect the light through the top plate.

Also disclosed herein are implementations of a pointer for a gauge for an instrument cluster of a vehicle. The pointer includes an arm having a bottom plate and a top plate. The bottom plate and the top plate are on opposed sides of the arm. The pointer also includes a light source coupled to the arm. The light source emits a light to illuminate the pointer. The pointer further includes a reflective layer disposed on the bottom plate to reflect the light through the top plate.

Also disclosed herein are implementations of a process of illuminating a pointer of a gauge for an instrument cluster. The process includes emitting a first light from a first portion of the pointer and reorienting the first light for transmission out of the pointer proximate to the first portion. The process also includes emitting a second light from a second portion of the pointer after emitting the first light and reorienting the second light for transmission out of the pointer proximate to the second portion. The process further includes turning off the first light prior to turning off the second light, wherein illuminating the pointer achieves a sweeping effect.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an exemplary instrument cluster in accordance with one aspect of the present disclosure;

FIG. 2 is a side view of the pointer in accordance with one aspect of the present disclosure; and

FIG. 3 is a flow chart of an exemplary process for illuminating a pointer of a gauge in accordance with one aspect of the present disclosure.

### DETAILED DESCRIPTION

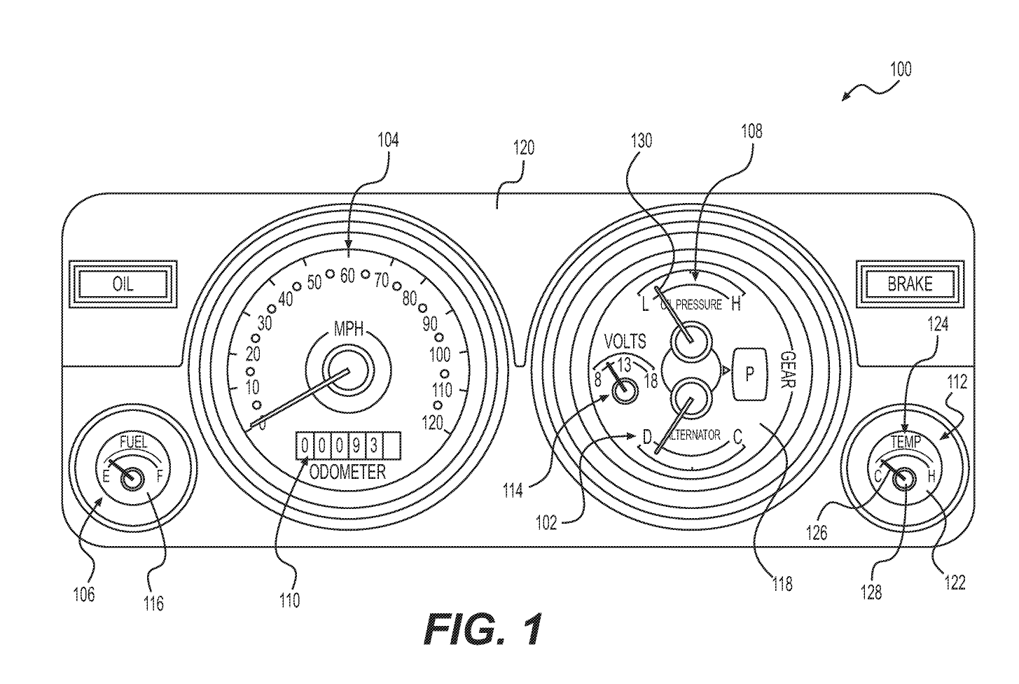

FIG. 1 illustrates an instrument cluster 100 in accordance with one aspect of the present disclosure. The instrument cluster 100 includes various gauges that may be digital or analog gauges. The instrument cluster 100 includes analog gauges such as a tachometer 102, a speedometer 104, a fuel gauge 106, an oil pressure gauge 108, an odometer 110, an engine temperature gauge 112, a battery voltage gauge 114. The tachometer 102 displays the revolutions per minute, or RPM, in an engine. The speedometer 104 displays the operational speed of a vehicle. The fuel gauge 106 displays the amount of fuel in the vehicle. The oil pressure gauge 108 displays the amount of oil in the vehicle. The odometer 110 displays the number of miles traveled by the vehicle. The engine temperature gauge 112 displays the temperature of the engine in degrees. The battery voltage gauge 114 displays the amount of power left in a battery of the vehicle. The instrument cluster 100 may have a variety of additional gauges that display specific information on the vehicle's performance, such as a boost gauge, air/fuel ratio gauge, turbo boost gauge, or a vacuum gauge. Any of the gauges may be analog or digital gauges or both. For example, the speedometer 104 may have an analog gauge pointing to a speed and a digital gauge displaying the speed. Any of the gauges may be located in different configurations. The gauges may also be different shapes and/or sizes. Any gauge may be located on a single face plate. For example, the fuel gauge 106 is located on a face plate 116. Multiple gauges may be located on the same face plate. For example, the tachometer 102, the oil pressure gauge 108, and the battery voltage gauge 114 are located on a face plate 118.

An instrument cluster cover 120 covers the instrument cluster 100. The instrument cluster cover 120 protects the components of the instrument cluster 100 from the elements while allowing an occupant to view the components. The instrument cluster cover 120 may be a lens. The lens may be made from a material such as plastic. The instrument cluster cover 120 may be clear or tinted to reduce the amount of glare and light entering through the instrument cluster cover 120, thereby enhancing visibility of the gauges. The instrument cluster cover 120 may be a single piece that covers the entire instrument cluster 100. The instrument cluster cover 120 may include separate components to cover the gauges individually or in groups.

Each gauge may include a face plate, a gauge indicator, and a pointer. For example, the temperature gauge includes a face plate 122, a gauge indicator 124, and a pointer 126 with a pointer cap, or cap 128. Unless otherwise specified, the face plate 122, the gauge indicator 124, the pointer 126, and the cap 128 represents any disclosed face plate, gauge indicator, pointer, and cap, respectively. The face plate 122 includes at least one of text, numbers, a cutout for displaying information, a cutout for attaching a device, or another information display, such as the gauge indicator 124. The gauge indicator 124 is located on the face plate 122. The gauge indicator 124 provides information, such as a curved bar in the temperature gauge indicating a temperature of an engine in the vehicle or a range of numbers indicating the speed for the speedometer 104. The pointer 126 is rotatably coupled to the face plate about an axis. The cap 128 is coupled to the pointer 126. The cap 128 may be a cone-shaped cover for a portion of the pointer 126 about the axis of rotation. The cap 128 may rotate with the pointer 126. The pointer 126 rotates about the face plate 122 depending on the vehicle information. For example, if the vehicle has an oil leak, the pointer 130 rotates toward an “L” for low oil pressure as the oil pressure decreases and points to the gauge indicator at the proper indication for oil pressure. If the oil leak is fixed and the pressure builds, the pointer 130 rotates toward the “H” for high oil pressure and stops the pointer when the pointer 130 points to the gauge indicator at the proper indication for oil pressure. The instrument cluster 100 may include additional and/or fewer components and is not limited to those illustrated in FIG. 1.

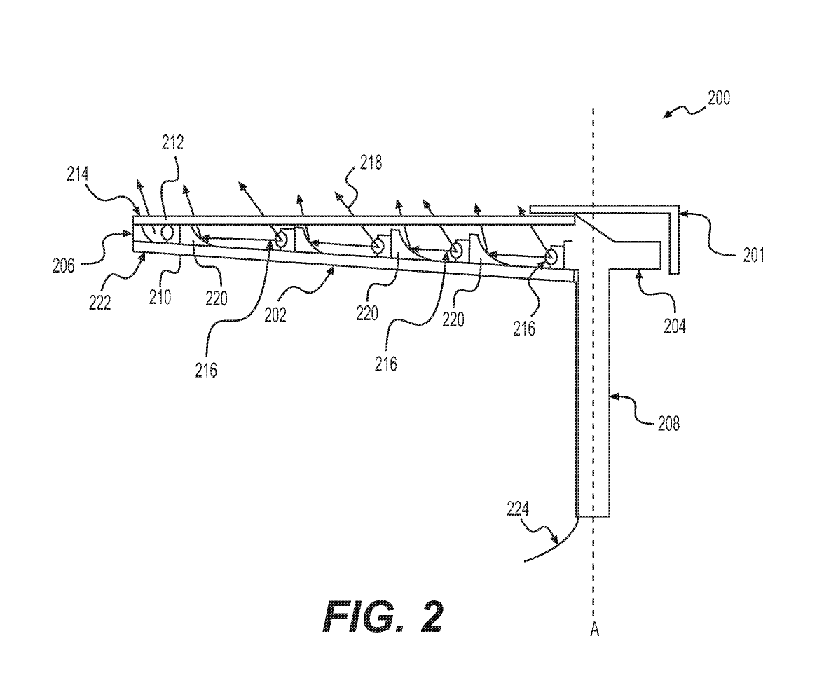

Referring to FIG. 2, the pointer 200 includes an arm 202 having first portion or a tail 204 and a second portion or a tip 206. The tail 204 and the tip 206 are at opposed ends of the arm 202. The arm 202 may be straight or tapered. The arm 202 may have a varied thickness and/or width. The arm 202 includes a hollow portion. The arm 202 is attached to a shaft 208 at the tail 204. The pointer 200 includes an arm 202 having a bottom plate 210 and a top plate 212. The bottom plate 210 and the top plate 212 are on opposed sides of the arm 202. The pointer 200 may include a translucent layer 214. The translucent layer 214 is coupled to at least a portion of the top plate 212. The translucent layer 214 allows light 218 to pass through. The translucent layer 214 also may reduce visibility of and/or hide the components within the pointer 200, such as the light source 216, so that the components are not visible or less visible. In other words, an occupant located inside of the vehicle will see the pointer 200 but not the components located inside of the pointer 200.

The pointer 200 can be made of plastic, metal, or another material. The pointer 200 may be made of a combination of materials. For example, the arm 202 may be made of a clear or translucent plastic and the shaft 208 may be made of metal or a different plastic material. At least a portion of the arm 202 is made of a material that allows light 218 to pass through. The pointer 200 may have a single body that includes the arm 202 and shaft 208. The arm 202 and shaft 208 may be coupled together. For example, the arm 202 and shaft 208 may be attached with fasteners.

A cap 201 is coupled to the pointer 200 at the tail 204. The shaft 208 is operatively attached to the face plate (not shown) such that the pointer 200 may rotate and point toward various gauge indicators, e.g. the gauge indicator 124. The shaft 208 may be hollow or solid. The shaft 208 may be a cylindrical shape or another shape to allow for rotation. The shaft 208 may be connected to a rotator, such as a stepper motor. The rotator rotates the pointer 200 via the shaft 208 about an axis A so that the arm 202 points to the gauge indicator. The rotator may rotate the arm 202 about the axis A in response to a condition of the vehicle. The condition of the vehicle may include a change in temperature, speed, oil pressure, RPMs, or another vehicle condition having a gauge.

The pointer 200 includes a light source 216. The light source 216 is located in the arm 202. The light source 216 may be coupled to the bottom plate 210. The light source 216 is positioned to emit the light 218 along the arm 202 and a reflector 220 is positioned to reflect the light 218 through the top plate 212. The light source 216 may be coupled to another location of the arm 202, such as a side plate or the top plate 212. The light source 216 may be positioned to emit the light 218 along the arm 202 and through the tip 206 of the arm 202. The light source 216 illuminates the pointer 200 by emitting light 218. The light source 216 may be directly integrated along the arm 202. In this arrangement, the light sources 216 may emit the light 218 directly through the top plate 212 or indirectly by reflective surfaces reorienting the light 218 in the arm 202. The light source 216 may be a light 218 emitting diode (LED).

The pointer 200 may include a plurality of light sources 216. The light sources 216 may be positioned in series along the arm 202. The arm 202 is illuminated to provide improved lighting and aesthetics to various instrument cluster 100 implementations. Multiple light sources 216 are located in the arm 202, together with multiple reflective surfaces isolating the light sources 216 from one another. This arrangement allows for multiple colors and animation in the arm 202.

The reflective surfaces may include the reflector 220 and/or a reflective layer 222. The reflector 220 may be coupled to the bottom plate 210. The pointer 200 may include a plurality of reflectors 220 coupled to the bottom plate 210. The reflective layer 222 is disposed on at least a portion of the bottom plate 210. The reflective layer 222 may be a coating. The reflective layer 222 reflects light 218. Both the reflector 220 and the reflective layer 222 may be positioned to reflect the light 218 emitted from the light source 216 toward the top plate 212. In particular, the reflector 220 and the reflective layer 222 reorient the light 218 within the arm 202. If the light 218 is not reflected, the light 218 may travel along the arm 202 through the tip 206. The light 218 may also be blocked from traveling through the tip 206. The light 218 may also travel through both the tip 206 and the top plate 212. The light 218 may travel in other directions through the pointer 200.

Each light source 216 and each reflector 220 may be adjacent and coupled along the arm 202 in a series of light sources 216 and reflectors 220. The light 218 may be emitted in a variety of ways. Light animation may provide additional information, such as by alerting an occupant of the vehicle condition. Each of the plurality of light sources 216 may emit light 218 having varying characteristics of at least one of brightness, intensity, and color. For example, the light source 216 emits a red light when the vehicle is low on fuel. The light source 216 emits a green when the fuel is full. The light source 216 emits a range of colors of light 218 as the pointer 200 rotates from a full gauge indicator to an empty gauge indicator. The light source 216 may emit high light. The light source 216 may emit a low light. The light source 216 may emit a high light at a certain light source 216 and a low light at another light source 216 along the arm 202. For example, in high ambient light 218 conditions, high light may be emitted so that the occupant can view the vehicle condition. In low ambient light 218 conditions, the light source 216 may emit low light so that the occupant is not visually impaired by the light 218.

The plurality of light sources 216 may be turned on and off sequentially to illuminate the pointer 200 and emit light 218 through the top plate 212 and/or through the tip 206. The plurality of light sources 216 may be turned on and off sequentially to illuminate the pointer 200 in a sweeping motion. The light 218 acts as a sweeping light that travels from one extremity of the pointer 200 to another extremity. For example, the light source 216 emits light 218 that travels from the tail 204 toward the tip 206. Each light source 216 emits light 218 for only a certain period of time such that the light 218 sweeps from the tip 206 to the tail 204. The sweeping may also occur from the tip 206 to the base. The light sources 216 may repeat the sweeping. The light sources 216 may also repeat turning on and off to represent blinking. The light 218 may emit from the arm 202 at a single portion of the arm 202. The light 218 may emit from the arm 202 at various portions of the arm 202. The light 218 may emit from the entire arm 202.

The light source 216 may have an electrical connection 224 to an energy source. The energy source provides energy to the light source 216 to emit light 218. The electrical connection 224 may be accomplished via the pointer 200 by the use MID technology, such as printed electrical tracks. The electrical connection 224 may be accomplished via a molded or an over-molded conductive part. The electrical connection 224 may be coupled to the shaft 208. The electrical connection 224 may be located within the shaft 208 or outside of the shaft 208. For example, the electrical connection 224 is connected to the light source 216 located near the tail 204. The pointer 200 may include more than one electrical connection 224. The energy source may include battery power, solar power, or another energy source. The pointer 200 may include additional and/or fewer components and is not limited to those illustrated in FIG. 2.

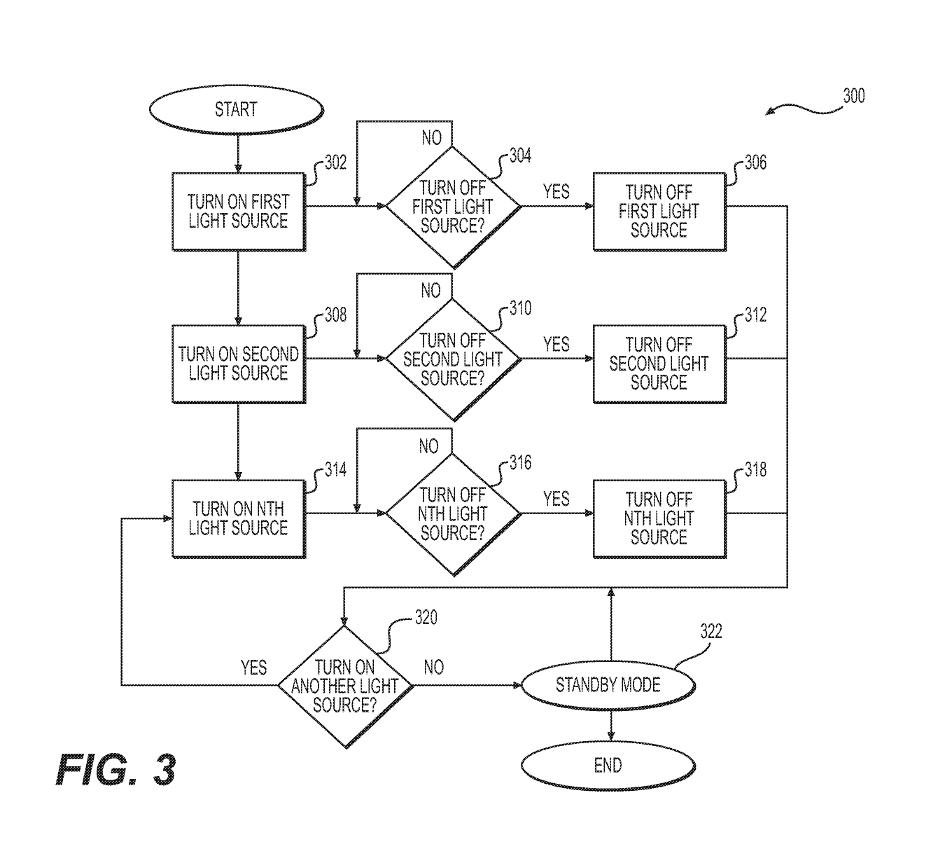

FIG. 3 is a flow chart of an exemplary process 300 of illuminating a pointer 200 of a gauge for an instrument cluster 100. Generally speaking, the components of FIG. 2 are used in the process 300. In this exemplary embodiment, a first portion represents a portion of the arm 202 proximate the tail 204, a second portion represents a portion of the arm 202 proximate the tip 206, and a middle portion represents a portion of the arm 202 between the tail 204 and the tip 206. The middle portion may be located at the tail 204 or the tip 206. In other embodiments, the first portion, the middle portion, and the second portion may be any portion on the pointer 200.

Process 300 starts at step 302. Step 302 includes a first light source emitting a first light at the first portion. After the first light is emitted in step 302, the first light for transmission out of the pointer 200 may be reoriented proximate to the first portion. Fixed reflective surfaces may be used to reorient the light. Process 300 proceeds to decision step 304 and step 308. At decision step 304, a decision is made to keep the first light source on or turn the first light source off. If the first light source should remain on, decision step 304 loops until the first light source should be turned off. At step 306, the first light source is turned off and process 300 continues to decision step 320. At decision step 320, a decision is made to turn on another light source. If the decision is to not turn on another light source, process 300 continues to step 322. Step 322 is a standby mode. The process 300 may end or remain in standby mode may be for period of time. After the period of time, process 300 for the first light source ends. If the decision is to turn on another light source, process 300 continues to step 314 as described in further detail below. In another embodiment, the process 300 may also continue to step 302, step 308, or any combination of steps to turn on the light source.

Step 308 includes a second light source emitting a second light at the middle portion. After the second light is emitted in step 308, the second light for transmission out of the pointer 200 may be reoriented proximate to the middle portion. Fixed reflective surfaces may be used to reorient the light. Process 300 proceeds to decision step 310 and step 314. At decision step 310, a decision is made to keep the second light source on or turn the second light source off. If the second light source should remain on, decision step 310 loops until the second light source should be turned off. At step 312, the second light source is turned off and process 300 continues to decision step 320. Process 300 continues for the second light source as described above for the first light source.

Step 314 includes an nth light source emitting an nth light at the middle portion. After the nth light is emitted in step 314, the nth light for transmission out of the pointer 200 may be reoriented proximate to the middle portion. Fixed reflective surfaces may be used to reorient the light. The location of the nth light source may be anywhere on the arm 202. The last nth light source turned on may be located at the second portion. The light sources 216 may be located in a series along the arm 202 from the first portion to the second portion. The light sources 216 may be located in the series along the arm 202 from the second portion to the first portion. The light sources 216 may be located in any combination and/or location. Process 300 proceeds from step 314 to decision step 316. At decision step 316, a decision is made to keep the nth light source on or turn the nth light source off. If the nth light source should remain on, decision step 316 loops until the nth light source should be turned off. At step 318, the nth light source is turned off and process 300 continues to decision step 320. Process 300 continues for the nth light source as described above for the first light source.

The process 300 may include additional and/or fewer processes and is not limited to those illustrated in FIG. 3. For example, process 300 may include emitting the second light from the second portion of the pointer 200 after emitting the first light and reorienting the second light for transmission out of the pointer 200 proximate to the second portion. Process 300 may further include turning off the first light prior to turning off the second light, wherein illuminating the pointer 200 achieves the sweeping effect. The second light source may emit the second light after the first light source turns off the first light. Alternatively, the second light source may emit the second light while the first light source emits the first light. The plurality of light sources may be turned on at the same time or at separate times. The plurality of light sources may be turned off at the same time or at separate times. Some light sources may be turned on simultaneously, while other light sources are in an off state.

Process 300 may also include emitting the middle light from the middle portion of the pointer 200 after emitting the first light and before emitting the second light and reorienting the middle light for transmission out of the pointer 200 proximate to the middle portion. Process 300 may also include turning off the middle light after turning off the first light and prior to turning off the second light. The middle light may be emitted while the first light and the second light are being emitted.

Any lights 218 being emitted may have different characteristics. Process 300 may include emitting the first light and the second light having varying characteristics of at least one of brightness, intensity, and color. For example, process 300 may include emitting the second lighting having a high intensity after emitting the first light with a low intensity. The intensity may change over time. The light 218 emitted may start out with one characteristic and change after a set time. For example, the first light source emits the first light with high intensity that dims when the second light source emits the second light with high intensity.

The light source 216 may illuminate the pointer 200 via a direct or an indirect means. The light source 216 may emit light directly through the tip 206. The light source 216 may emit light directly through the top plate 212. The light source 216 may also illuminate the pointer 200 and indirectly transmit the light 218 through the top plate 212 of the pointer 200. In this situation, the light 218 is indirectly reoriented by the reflective surface, such as the reflective layer 222 and/or the reflector 220. The reoriented light may travel toward and through the top plate 212.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An instrument cluster for a vehicle, comprising:
a gauge having a face plate, a pointer rotatably coupled to the face plate, and a gauge indicator on the face plate;
wherein the pointer comprises:
an arm, the arm including a bottom plate and a top plate on opposed sides of the arm;
a reflector coupled to the bottom plate; and
a light source coupled to the bottom plate; and
wherein the light source is positioned to emit a light along the arm and the reflector is positioned to reflect the light through the top plate.

2. The instrument cluster of claim 1, wherein the top plate includes a translucent layer.

3. The instrument cluster of claim 1, wherein the light source is a light emitting diode (LED).

4. The instrument cluster of claim 1, further comprising:
an energy source electrically connected to the light source, the energy source providing energy to the light source to emit light.

5. The instrument cluster of claim 4, wherein the energy source is electrically connected to the light source via at least one of a molded interconnect device (MID), a molded conductive part, and an over molded conductive part.

6. The instrument cluster of claim 1, wherein the pointer includes a plurality of light sources.

7. The instrument cluster of claim 6, wherein the pointer includes a plurality of reflectors, wherein the plurality of light sources and reflectors are adjacent and coupled along the arm in a series.

8. The instrument cluster of claim 6, wherein the plurality of light sources are turned on and off sequentially to illuminate the pointer in a sweeping motion.

9. The instrument cluster of claim 6, wherein each of the plurality of light sources emits light having varying characteristics of at least one of brightness, intensity, and color.

10. The instrument cluster of claim 1, further comprising:
a rotator coupled to the pointer and the face plate, wherein the rotator rotates the pointer about an axis, and wherein the arm points to the gauge indicator.

11. A pointer for a gauge for an instrument cluster of a vehicle, comprising:
an arm having a bottom plate and a top plate, wherein the bottom plate and the top plate are on opposed sides of the arm;
a light source coupled to the arm, the light source emits a light to illuminate the pointer; and
a reflective layer disposed on the bottom plate to reflect the light through the top plate.

12. The pointer of claim 11, further comprising:
a rotator coupled to the pointer for rotating the arm about an axis in response to a condition of the vehicle.

13. The pointer of claim 11, further comprising:
a plurality of light sources coupled to the arm in a series, wherein the light sources sequentially emit light.

14. The pointer of claim 11, wherein the top plate includes a translucent layer to reduce visibility of the light source from outside of the pointer.

15. The pointer of claim 11, wherein light is reflected from the pointer only through the top plate.

16. A process of illuminating a pointer of a gauge for an instrument cluster comprising:
emitting a first light from a first portion of the pointer;
reorienting the first light for transmission out of the pointer proximate to the first portion;
emitting a second light from a second portion of the pointer after emitting the first light;
reorienting the second light for transmission out of the pointer proximate to the second portion; and
turning off the first light prior to turning off the second light, wherein illuminating the pointer achieves a sweeping effect.

17. The process of claim 16, further comprising:
emitting a middle light from a middle portion of the pointer after emitting the first light and before emitting the second light;
reorienting the middle light for transmission out of the pointer proximate to the middle portion; and
turning off the middle light after turning off the first light and prior to turning off the second light.

18. The process of claim 16, wherein emitting the second light is occurs after turning off the first light.

19. The process of claim 16, wherein emitting the first light and the second light having varying characteristics of at least one of brightness, intensity, and color.

20. The process of claim 16, further comprising:
transmitting the light through a top plate of the pointer.
